(19) United States
(12) Patent Application Publication
(10) Pub. No.: US 2016/0083265 A1
(43) Pub. Date: Mar. 24, 2016

(54) SYSTEM AND METHOD USING SENSORS TO CONTROL A VERTICAL LIFT DECANTER IN A WASTE LIQUID TREATMENT SYSTEM

(71) Applicant: ClearCove Systems, Inc., Rochester, NY (US)

(72) Inventors: Terry Wright, Rochester, NY (US); Timothy J. Cornelison, Saugerties, NY (US); Arvid Abrams, Fort Plain, NY (US)

(21) Appl. No.: 14/490,994

(22) Filed: Sep. 19, 2014

(51) Int. Cl. C02F 1/00; B01D 29/60; B01D 29/96

(52) U.S. Cl. CPC C02F 1/008; B01D 29/96; B01D 29/606; B01D 29/603; C02F 2201/002; C02F 2209/03; C02F 2209/40

(57) ABSTRACT

A decanter system for separating liquid from solids in a liquid mixture tank includes a screen structure which is at least partially submersible in a fluid influent in the tank. The screen structure includes a liquid outlet for removal of screened liquid. A lifting mechanism is attached to the structure for raising and lowering the structure with respect to the tank. A control mechanism governs the lifting mechanism for regulating a vertical position of the structure with respect to the tank. The control mechanism includes a first pressure sensor within the structure, a second pressure sensor within the tank, a proximity transducer within the tank, an effluent outlet control valve, a flow meter, and a controller. A method for separating liquid from solids in a tank is also described.

### FIELD OF THE APPLICATION

The application relates to waste liquid treatment facilities and particularly to waste liquid treatment facilities which use a screen box to remove liquid supernatant from a waste liquid tank.

### BACKGROUND

A waste liquid treatment system or decanter system is used to treat waste liquids, such as waste water. Generally, after some solids are removed from influent waste water by techniques such as weirs and bar racks, the waste fluid is allowed to settle in more or more settling or clarification tanks. As time passes, the waste fluid begins to stratify into layers of varying clarity, with the clearest fluid near the top of the clarification tank. The clearest fluid (e.g. water) near the top of the clarification tank is called supernatant.

### SUMMARY

According to one aspect, a decanter system for separating liquid from solids in a liquid mixture tank includes a screen structure which is at least partially submersible in a fluid influent in the tank, having screening extending over at least a portion of an outer surface thereof for carrying out the separating and having an open interior. The screen structure defines an area within the tank. The screen structure includes a liquid outlet for removal of screened liquid from within the screen structure and is constructed such that liquid cannot pass from outside of the screen structure to inside of the screen structure without passing through the screening. A lifting mechanism is attached to the structure for raising and lowering the structure with respect to the tank. A control mechanism governs the lifting mechanism for regulating a vertical position of the structure with respect to the tank. The control mechanism includes a first pressure sensor within the structure, a second pressure sensor within the tank, a proximity transducer within the tank, an effluent outlet control valve, a flow meter, and a controller.

In one embodiment, the proximity transducer includes a sensor technology selected from the group consisting of an optical sensor, an acoustic sensor, a radar sensor, an ultrasonic sensor, a radio frequency (RF) sensor, a magnetic sensor, and an electromagnetic (EM) sensor.

In another embodiment, the liquid includes water.

According to another aspect, a decanter system for separating liquid from solids from a fluid in a clarification tank includes a screen box assembly (SBX) at least partially submersible in the fluid in the clarification tank. The SBX has a screen extending over at least a portion of a SBX outer surface thereof for carrying a supernatant of the fluid out the clarification tank. The SBX has an open interior. The SBX defines a volume within the tank when the SBX is lowered into the clarification tank. The SBX includes a supernatant outlet for removal of screened fluid from within the SBX. The SBX is constructed such that the fluid substantially cannot pass from outside of the SBX to inside of the SBX without passing through the screening. A lifting mechanism is attached to the SBX to raise and lower the SBX to a vertical position with respect to the tank. At least one SBX sensor measures a position of the SBX. At least one fluid level sensor measures a fluid height of the fluid in the clarification tank. A controller is communicatively coupled to the lifting mechanism, the at least one SBX sensor, and the at least one fluid level sensor. The controller is programmed to control the lifting mechanism and to cause the SBX to move to a different vertical position over a SBX operation cycle in response to measurements received from the at least one SBX sensor and the at least one fluid level sensor.

In one embodiment, the decanter system further includes at least two or more SBX sensors or at least two or more fluid level sensors, and an alarm is enunciated where measurements from at least two or more SBX sensors or at least two or more fluid level sensors differ by more than a first pre-determined difference.

In another embodiment, the alarm further includes a notification selected from the group consisting of multiple lights (Red—Serious; Yellow—Out of spec condition) positioned in the facility, a text message, a phone call, an email, and a FAX.

In yet another embodiment, the decanter system further includes at least two or more SBX sensors or at least two or more fluid level sensors, and at least one operation of the decanter system is halted where measurements from the at least two or more SBX sensors or the at least two or more fluid level sensors differ by more than a second pre-determined difference larger than the first pre-determined difference.

In yet another embodiment, the at least one SBX sensor to measure the position of the SBX or at least one fluid level sensor to measure the fluid height of the fluid in the clarification tank includes a sensor technology selected from the group consisting of, a pressure sensor, an optical sensor, an acoustic sensor, a radio frequency (RF) sensor, a magnetic sensor, and an electromagnetic (EM) sensor.

In yet another embodiment, the acoustic sensor includes an ultrasonic or a sonar sensor.

In yet another embodiment, the optical sensor includes a lidar sensor or a ladar sensor.

In yet another embodiment, the optical sensor includes a photodetector sensor or an optical encoder sensor.

In yet another embodiment, the RF sensor includes a radar sensor.

In yet another embodiment, the magnetic sensor includes a magnetic field sensor.

In yet another embodiment, the EM sensor includes an Eddy current sensor.

In yet another embodiment, the EM sensor or the RF sensor includes a capacitive sensor.

In yet another embodiment, the capacitive sensor includes the SBX configured as a first plate of the capacitive sensor and the clarification tank configured as a second plate of the capacitive sensor, and wherein the SBX is substantially electrically isolated from the clarification tank.

In yet another embodiment, the decanter system further includes a flow meter disposed in a hose or pipe fluidly coupled to the supernatant outlet, the flow meter communicatively coupled to the controller.

According to yet another aspect, a method for separating liquid from solids in a tank, including the steps of: providing a decanter system including a screen structure at least partially submersible in the liquid in the tank, having screening extending across at least a portion of an outer surface thereof for carrying out the separating and having an open interior, the screen structure defining an area within the tank, the screen structure including a liquid outlet for removal of screened liquid from within the screen structure and being constructed such that liquid cannot pass from outside of the screen structure to inside of the screen structure without passing through the screening; a lifting mechanism attached to the structure for raising and lowering the structure with respect to the tank; and a control mechanism governing the lifting mechanism for regulating a vertical position of the structure with respect to the tank, wherein the control mechanism includes a first pressure sensor attached to the structure, a second pressure sensor within the tank, a proximity sensor within the tank and an effluent outlet control valve, a flow meter, an encoder to measure the vertical position of the structure with respect to the tank and a programmable controller; determining a setpoint flow for effluent from the tank through the effluent outlet control valve; calculating an immersion depth for the structure in the liquid in the tank to achieve the setpoint flow; immersing the structure to the immersion depth responsive to signals from the encoder and the proximity sensor; monitoring output data from the first and second pressure sensors, the proximity sensor, and the flow meter to determine an instantaneous flow through the effluent outlet control valve; adjusting as needed the vertical position of the structure with respect to a fluid level in the tank to maintain the calculated immersion depth or the setpoint flow; and adjusting the immersion depth and a position of the effluent outlet control valve as needed to provide a desired flow rate of effluent through the flow meter.

In one embodiment, the step of providing includes providing the proximity sensor elected from the group consisting of, an optical sensor, an acoustic sensor, a radio frequency (RF) sensor, a magnetic sensor, and an electromagnetic (EM) sensor.

In another embodiment, the method further includes the step of raising the structure from the liquid in the tank to allow filtrate within the structure to back wash the screening.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1A shows an isometric view from above of an SBX and central lifting column, showing a lifting cable attachment;

FIG. 1B shows is an enlarged view of the lifting cable attachment shown in FIG. 1A;

FIG. 2A shows an elevational cross-sectional view of an exemplary SBX in lowered position, freshly cleaned and entering into service;

FIG. 2B shows an elevational cross-sectional view of an SBX having been controllably lowered to follow a drop in tank level to maintain a desired immersion level of the SBX;

FIG. 2C shows an elevational cross-sectional view of an SBX having been controllably lowered still farther to follow a further drop in tank influent level to maintain a desired immersion level of the SBX;

FIG. 2D shows an elevational cross-sectional view of an SBX having been controllably raised from immersion to permit backwash of the screens in the SBX;

FIG. 3A shows a cross-sectional view of an exemplary wastewater treatment system with an SBX and pressure sensors; and

FIG. 3B shows a cross-sectional view of an exemplary wastewater treatment system with an a SBX position sensor and a fluid level sensor.

### DETAILED DESCRIPTION

As described hereinabove, a waste liquid treatment system or decanter system is used to treat waste liquids, such as waste water. Generally, after some solids are removed from influent waste water by us of techniques such as weirs and bar racks, the waste fluid is allowed to settle in more or more settling or clarification tanks. As time passes, the waste fluid begins to stratify into layers of varying clarity, with the clearest fluid near the top of the clarification tank. The clearest fluid (e.g. water) near the top of the clarification tank is called supernatant.

One technique for removing the supernatant is by use of a screen box assembly (SBX). Any suitable SBX can be used. Such SBX systems have been described, for example, in co-pending U.S. patent application Ser. No. 14/142,197, METHOD AND APPARATUS FOR A VERTICAL LIFT DECANTER SYSTEM IN A WASTE WATER TREATMENT SYSTEM (the '197 application), and co-pending U.S. patent application Ser. No. 14/142,099, FLOATABLES AMD SCUM REMOVAL APPARATUS FOR A WASTE WATER TREATMENT SYSTEM, both of which applications are incorporated herein by reference in their entirety for all purposes.

Exemplary SBX: A typical SBX includes a screen structure having an open interior and a SBX outer surface which is at least partially submersible in the influent in the tank. The SBX has a screening extending across at least a portion of an opening in the outer surface the SBX separating the exterior of the SBX from the interior of the SBX. The SBX includes a supernatant outlet (e.g. a liquid outlet) for removal of the screened supernatant fluid (e.g. removal of screened water supernatant) from within the SBX screen structure. Substantially, all of the supernatant passes through the screening. The SBX is typically constructed so that fluid substantially cannot pass from outside of the SBX screen structure to inside of the SBX without passing through the screening.

The SBX can be raised or lowered (i.e. change of vertical position) with respect to the surface level of the fluid in the settling tank by any suitable mechanical lifting mechanism. For example, a SBX can be raised or lowered by any suitable cable, pneumatic, or hydraulic lifting systems. Most commonly, a steel cable is used in conjunction with any suitable reversible motor to raise and lower SBX with reference to the surface level of the fluid in the clarification tank.

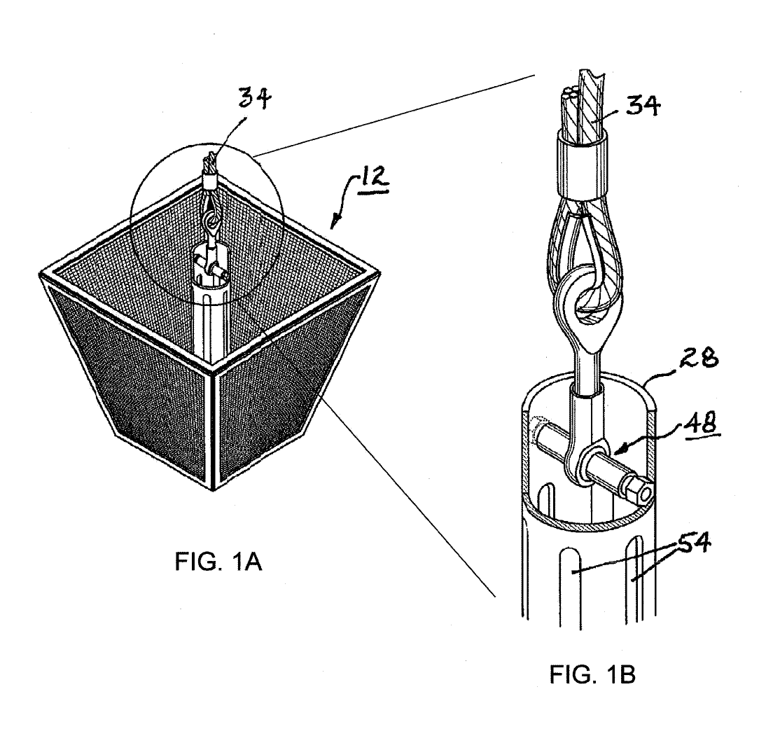

FIG. 1A shows an isometric view from above of an exemplary SBX with a central lifting column, and a lifting cable attachment. FIG. 1B shows is an enlarged view of the lifting cable attachment shown in FIG. 1A. A screen box lifting apparatus 28 can be pneumatic, hydraulic, winch and cable, or other mechanical apparatus to raise and lower the SBX 12. The vertical (up/down) movement of the SBX allows the SBX system to be installed in relatively small clarifier tanks of either circular or square geometry. Exemplary lifting apparatus 28 includes a cable 34. A ball and socket device 48 allows screen box 12 to move laterally as needed to reduce stress on the lifting device and to provide additional scouring of the screen box via slight horizontal motion caused by air scour and discharge hose rigidity

The motor that controls the position, velocity, and acceleration of the SBX can be controlled by any suitable computer processor based controller. Typically, an industry standard programmable logic controller (PLC), or supervisory control and data acquisition system (SCADA) system is used to control the workings of a waste fluid treatment system including the operation of a SBX lift motor.

Pressure sensors: A pressure sensor can be used to detect and measure the position of the SBX in the fluid in the clarification tank. Similarly, a pressure sensor can be used to measure the height and volume of fluid in the clarification tank.

Typical operation of a SBX in a clarification tank: After a predetermined settling time, there is sufficient supernatant to begin recovery of the supernatant from the clarification tank. The SBX is lowered, but generally never completely submerged, below the surface of the fluid into the supernatant layer. The supernatant flows through the screens of the SBX and out of the SBX via SBX discharge hose for subsequent fluid processing. The rate of flow of supernatant out of the clarification tank is affected by how far below the fluid surface the SBX is lowered and/or by a position of a supernatant outflow valve in the supernatant outflow pipe path. The flow of supernatant from the SBX can be monitored by the exemplary SCADA controller, such as, for example, by a flow meter in a pipe in the supernatant outflow path, typically following the SBX discharge hose.

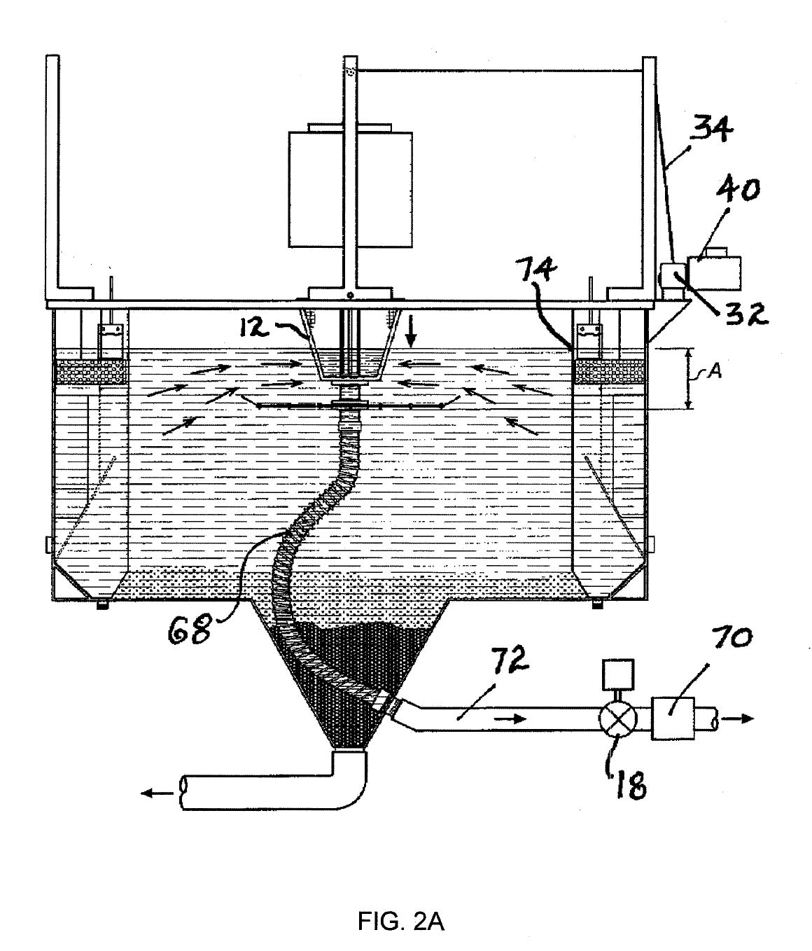

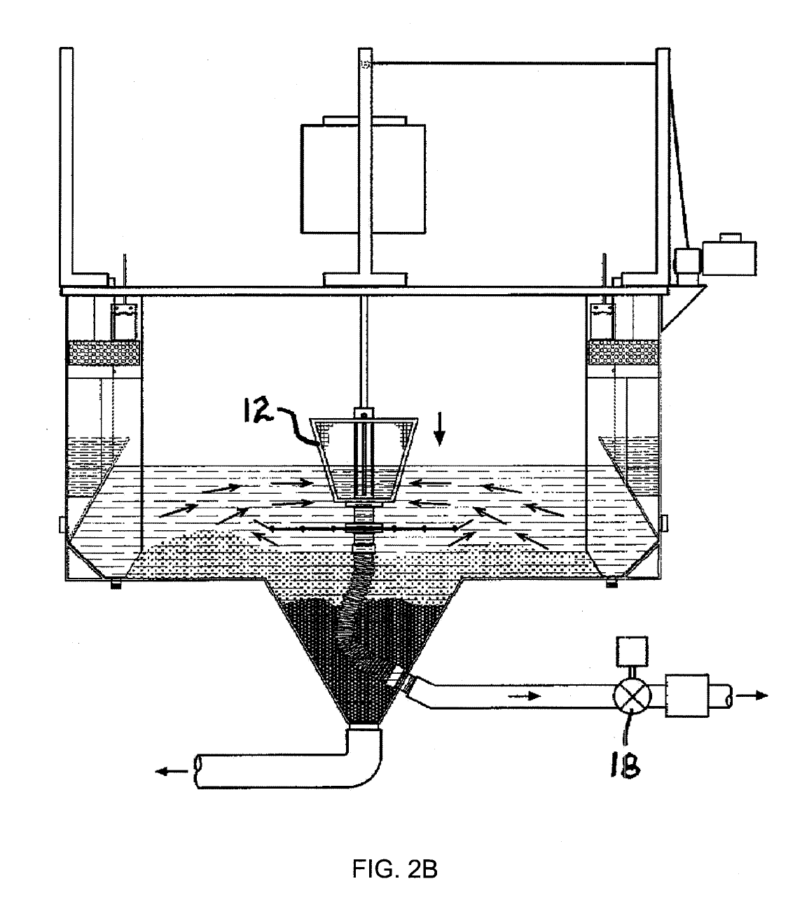

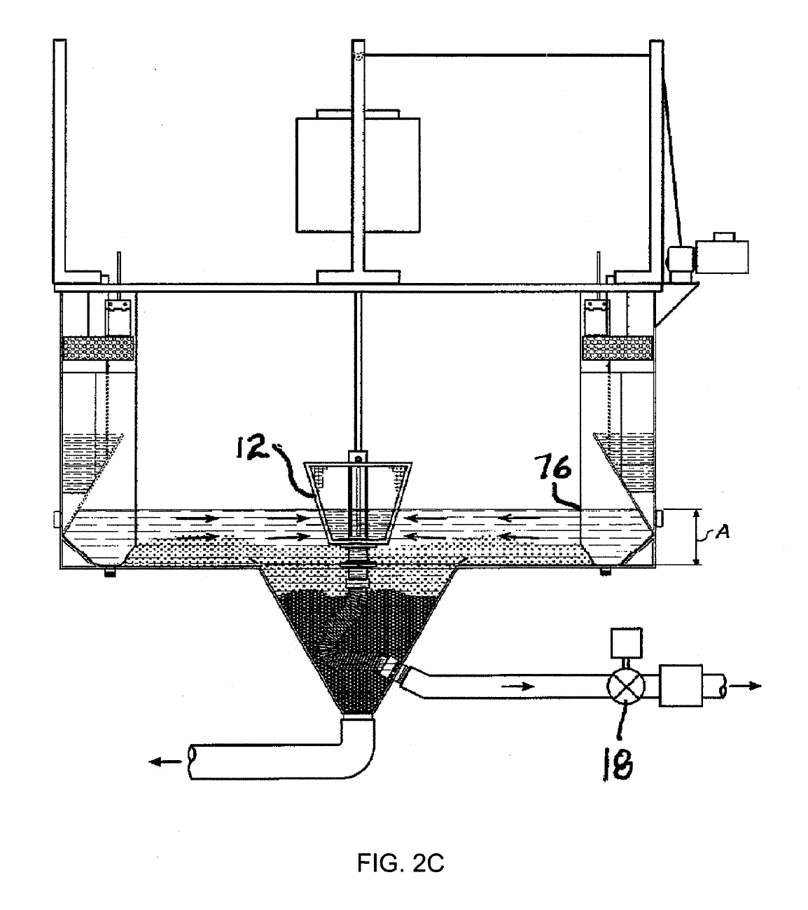

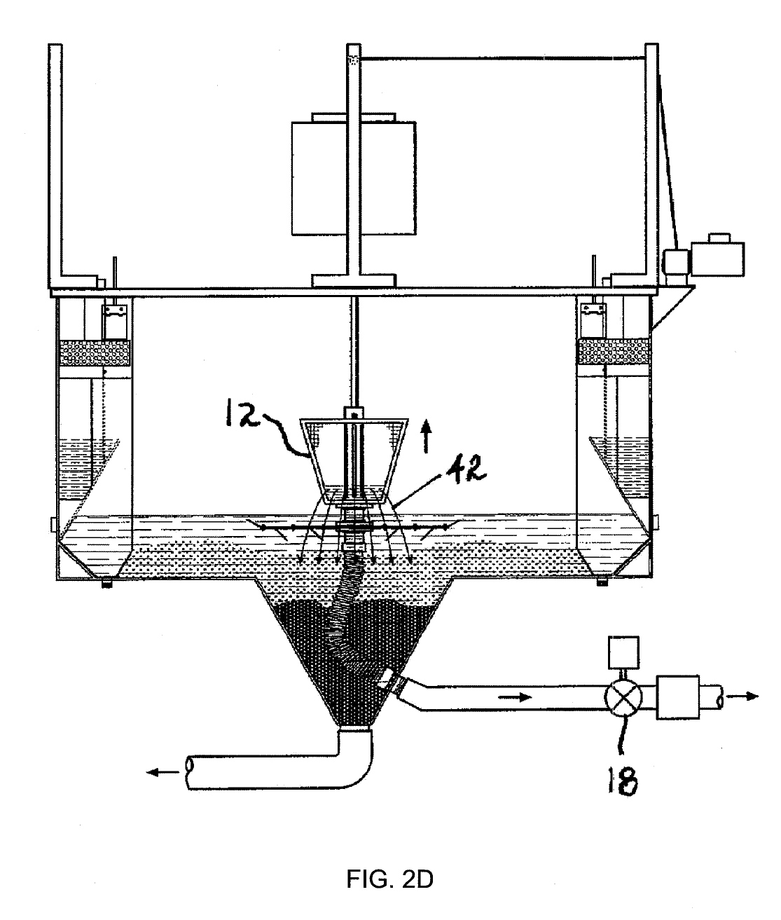

Exemplary SBX operation cycle: FIG. 2A shows an elevational cross-sectional view of an exemplary SBX in lowered position, freshly cleaned and entering into service. FIG. 2B shows an elevational cross-sectional view of an SBX having been controllably lowered to follow a drop in tank level to maintain a desired immersion level of the SBX. FIG. 2C shows an elevational cross-sectional view of an SBX having been controllably lowered still farther to follow a further drop in tank influent level to maintain a desired immersion level of the SBX, and FIG. 2D shows an elevational cross-sectional view of an SBX having been controllably raised from immersion to permit backwash of the screens in the SBX.

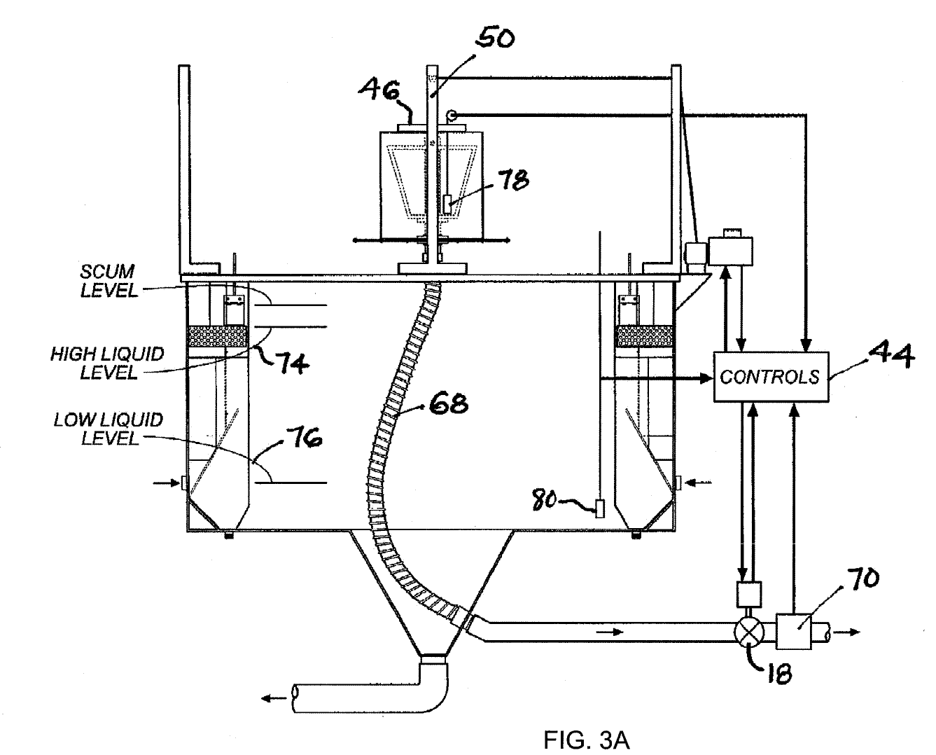

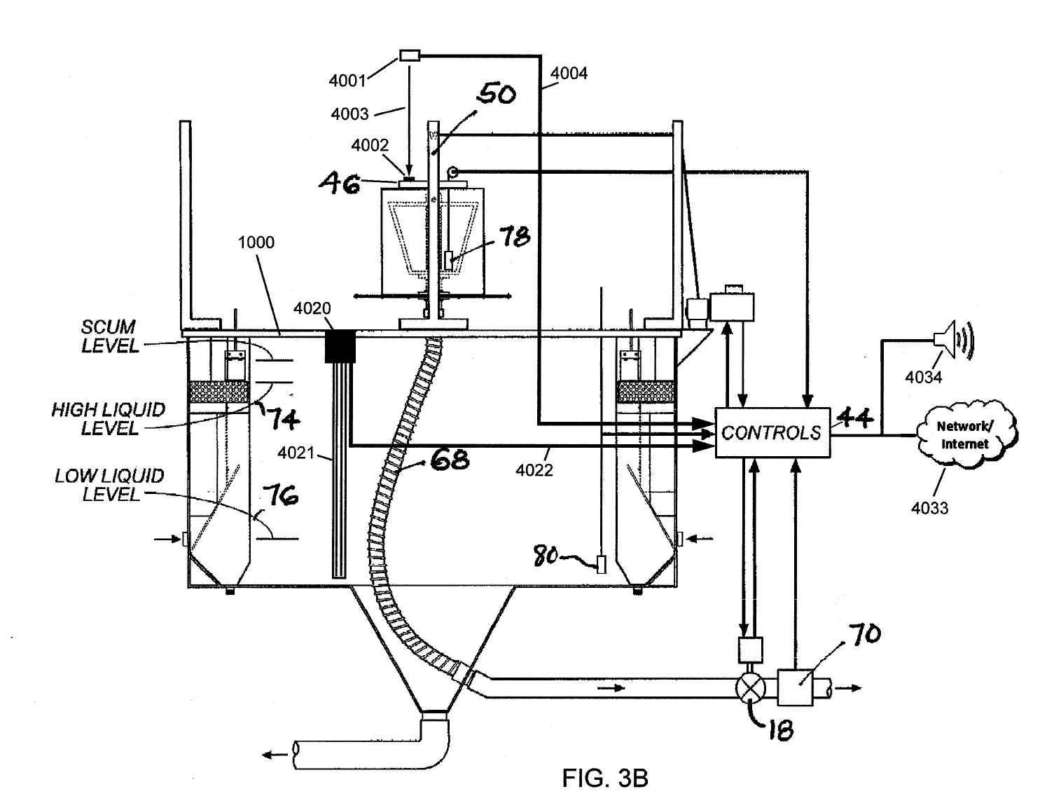

Now continuing with FIG. 2A, FIG. 2B, FIG. 2C, and FIG. 2D in more detail, for embodiments using gravity discharge flow, the flow rate of screened wastewater exiting the tank can be controlled, at least in part, by a modulating exit valve 18 that opens or closes incrementally to maintain a target flow rate set by the FIG. 3 controls 44 and measured by a flow meter 70 located upstream or downstream of the modulating exit valve.

The elevation of the discharge end of the screened wastewater pipe 72 is typically fixed as are the diameter and length of pipe connecting the SBX, SBX Stub Effluent Pipe, Discharge Hose, Flow Meter, and Modulating Valve to the discharge end. The piping and discharge location and elevation are a component on the infrastructure and generally not subject to change.

The change in liquid elevation within screen box 12 and the change in elevation of the screen box in the tank from a high liquid level 74 to a low liquid level 76 affect the hydraulic pressure in the screened effluent piping. The greater the elevation difference between inlet liquid elevation and discharge liquid elevation, the greater the pressure difference and thus flow. The lower the difference, the lower the pressure and thus flow.

Screen box 12 starts a decant cycle at the high liquid level 74 in the tank (FIG. 2A). Screen box 12 lowers at the same rate as the liquid level in the tank. When the tank liquid level reaches the low level set point, the screen box then is lifted upwards. The captured screened liquid exits outwards through the screen on the screen box. The faster the rise rate, the higher the exit velocity of the screened liquid moving through the screen. The high velocity creates a more vigorous backwash resulting in a thorough cleaning of the screen.

In some embodiments, the system employs a pair of pressure transducers 78, 80 (FIG. 3A) disposed within the screen box and the tank, respectively. Alternatively, pressure transducer 78 may be disposed in discharge hose 68 (not shown). The controls 44 (e.g. a SCADA controller) uses input from the flow meter 70, pressure transducers 78, 80, and tank encoder to automatically position the screen box in the liquid to provide the defined screen surface area in contact with the liquid. The controls 44 can automatically adjust the screen/liquid contact area to any desired value when the differential volume of the tank exceeds standard allowable deviations as in an abnormal flow condition that activates an alarm followed by adjustments in the target flow and decant cycles.

The flow rate of screened wastewater exiting the tank can also be controlled by a pump (not shown) instead of a modulating valve 18. A pump can be used when there is inadequate active volume (volume between high and low liquid level—depth of decant) or the discharge elevation and the liquid level in the screen box is not adequate to flow by gravity at the required rate. A variable frequency drive (VFD) can also provide an incremental discharge flow control.

Discharge Hose: As described above, flexible discharge hose 68 is connected to a pipe near the bottom of the tank for gravity discharge (the more normal situation) or in any other suitable location in the tank if the filtrate is pumped. Hose 68 can have swivel connections to allow the hose to twist as the screen box moves up and down in the tank or the hose can be an accordion type of hose/duct to increase in length as the screen box rises up to above the tank to the hood or contracts as the screen box decants to the low liquid level in the tank. An accordion type hose can provide less disturbance of the settled sludge.

FIG. 3A shows a cross-sectional view of a wastewater treatment system with an SBX and pressure sensors. Pressure sensor 78 can be used to measure the depth of the water above the pressure sensor 78. Pressure sensor 80 can be used to measure the depth of fluid in the clarification tank. Controls 44 (e.g. a SCADA controller) control a reversible motor to raise and the SBX into and out of the clarification tank.

It has been realized that beyond pressure measurements, other sensor technologies can be used in place of, or in addition to pressure measurements. In some embodiments, it is contemplated that the accuracy and/or reliability (e.g. robustness, less maintenance) of SBX positioning and rate of travel and supernatant flow rate can be improved by alternative sensor approaches. It is also contemplated that alternative sensor approaches can be used for redundant or equivalent SBX position and/or motion measurements for comparison to existing pressure measurements. Also, two or more redundant measurements using either the same or different sensor technologies (with or without pressure sensors) can be used for redundancy and/or fault detection.

As described in more detail in the '197 application, the position of the SBX in the fluid (e.g. the amount of SBX submersion in the fluid) is arranged to control the defined surface area of the screen in contact with the fluid so as to achieve the desired effluent discharge rate from the clarification tank while controlling the velocity of the fluid passing through the SBX screen such that the solids, fibers and other materials do not foul the screen. The overall effluent discharge rate is controlled by the modulating valve and measured with the flow meter flow. The SBX travel into the clarification tank generally should follow the rate of fall of the fluid level as the supernatant is removed. Errors in the positioning of the SBX can result in fouling of the screens, failure to achieve desired discharge rate of effluent from the clarification tank, or flooding of the SBX resulting in unscreened effluent being discharged.

As described in more detail hereinbelow, by use of various proximity sensor or proximity transducer technologies, a desired SBX position relative to the fluid level can be achieved. In some embodiments, the immersion depth can be automatically adjusted to maintain about a desired SBX immersion depth (e.g. a calculated SBX immersion depth) in response to feedback from a proximity sensor and/or an instantaneous flow measurement of supernatant flow from the supernatant outlet. The controller can also monitor the output data of such sensors for proper operation of the waste liquid treatment system. Also, as described in more detail hereinbelow, the controller, such as a programmable controller (e.g. any suitable programmable logic controller (PLC) or SCADA controller) can compare readings or measurements from two or more sensors and check for consistency between similar or dissimilar sensors and differences between similar measurements and/or dissimilar measurements which can be equated to each other for consistency.

Following a supernatant discharge portion of an SBX operation cycle, the SBX can be raised at a rate conducive to cleaning the SBX as an SBX discharge valve has been closed forcing supernatant back out of the SBX which cleans the SBX and SBX screens. The rate of rise should be fast enough to effect the supernatant SBX cleaning process, yet not so fast to cause undue mechanical stress to the motor, SBX lift system (e.g. a SBX lift cable and components), or SBX assembly. Also, the SBX should come to a controlled stop in a retracted position without undue swaying, or mechanical stress, such as caused by too high a rate of deceleration. The rate of SBX travel (e.g. SBX rise on retraction from the clarification tank) can be roughly constant before deceleration to a stop, or the rate of rise can be variable with time.

Sensed parameters: There are several sensed parameters believed to be useful as feedback parameter for a controller to use as input for controlling and checking the movement of an SBX into and out of the clarification tank fluid. There is typically present at least one SBX sensor to measure the position of the SBX as well as at least one fluid level sensor to measure the fluid height in the clarification tank. There can be two or more sensors of same type or different technologies for any given measurement.

Exemplary Sensor Technologies:

Pressure: Pressure sensors have been used and described in co-pending applications which can measure the depth of the fluid above the pressure sensor located in the SBX or SBX discharge pipe and the depth of the fluid in the clarification tank.

Capacitive sensors: It is believed that capacitive level sensors can be used measure the height of fluid in the clarification tank. FIG. 3B shows an exemplary capacitive sensor 4020 with capacitor electrodes (plates) as strips or rods shown in a protective cylinder of capacitive transducer 4021. Capacitive transducer 4021 is located within the clarification 1000 and extends downward into the fluid. The fluid height is measured by the height of the fluid column in the capacitive transducer 4021 which replaces air with a different dielectric of the fluid to the height of fluid. Sensors such as exemplary capacitive sensor 4020 are typically communicatively coupled to controller 44 via a wired connection 4022, wireless connection, or any other suitable connectivity method.

A capacitive sensor can also be mounted aside or below a SBX to measure the depth of immersion of the SBX into the fluid in the clarification tank. Such capacitive sensors, as known in the art, can be made from any two conductors which change capacitance as air between the two conductors is replaced by a different dielectric fluid on immersion into the fluid. Such sensors include, for example cylinders which shroud two vertical sheet or rod elements (which provide the two capacitor plates or surfaces) or a rod in a cylinder where the rod and the cylinder which are electrically separated from each other, provide the two capacitor plates.

It is contemplated that if the SBX is electrically isolated from the ground connection of the clarification tank, it might be possible use the SBX as one conductor of a capacitor, and the clarification tank as the second conductor. The measurement of SBX submersion would similarly reflect the immersion of the SBX capacitor element (i.e. the first capacitor plate) into the tank capacitor element (i.e. the second capacitor plate) with the capacitance changing by both the changing distance between the SBX metallic structure and the tank, as well as by the dielectric of the fluid surrounding the partially submerged SBX. The sensed parameter would likely be highly non-linear in comparison to a standard capacitive fluid level sensor using two parallel rods or plates with a variable height column of dielectric (the fluid), however it is contemplated that the data could be at least partially linearized by a process algorithm running on the controller.

Ultrasonic sensor: An ultrasonic sensor is an example of an acoustic sensor that can be mounted aside the SBX to measure a distance from a point on the SBX to the fluid surface (i.e. current fluid level) in the clarification tank. An ultrasonic sensor can also be mounted near the top of, or above a wall of the clarification tank to measure the height of the fluid in the clarification tank. With the extensive use of automotive ultrasonic sensors such as for distance to nearby objects as parking assistance sensors, it is contemplated that such sensors can be economically adapted to use in waste fluid treatment facilities. Other acoustic sensors are believed suitable to range measurement, such as, for example, any suitable type of sonar sensor.

Optical sensors: Optical sensors, such as a lidar sensor (also called ladar sensor) range finding technology can be used to measure both the distance of the SBX to the fluid (e.g. a lidar sensor side mounted on the SBX). A lidar sensor mounted near the top of the clarification tank, or above the clarification tank wall, can measure the depth of the fluid in the clarification tank

Other optical sensors can include photocells or photodetector sensors. For example, there can be an array of photodetectors on the side of the SBX which can sense different light levels and/or colors as the array is immersed into the fluid. Similarly, there can be an array of photodetectors in the clarification tank to detect the fluid level in the clarification tank.

Eddy current sensors: It is contemplated that an Eddy current sensor, typically an electromagnetic sensor (EM sensor), mounted either on the SBX and/or on the clarification tank can also sense the movement of the SBX with respect to the clarification tank.

Magnetic field sensors: A magnetic sensor mounted either on the SBX and/or on the clarification tank can sense the movement of the SBX with respect to the clarification tank. Such sensing can be enhanced by adding ferrous material and/or one or magnets to the surface being sensed. For example, if the magnetic sensor is mounted in or on the clarification tank, one or more magnets can be mounted on the SBX. A magnetic sensor can be configured to provide a distance between the SBX and a reference location on the clarification tank. There can also be magnets or ferrous targets which float, such as donut magnets or ferrous materials with floatation material affixed to cause the magnets to follow the fluid level. A magnetic field sensor, for example a magnetic sensor mounted on the SBX or wall of the clarification tank can sense the position of floating magnets with respect to a reference point, such as a reference point on or above the clarification tank wall.

Radar sensor: Radar range finding is an example of a radio frequency sensor (RF sensor) that can be used to measure both the distance of the SBX to the fluid (e.g. side mounted on the SBX) as well as the depth of the fluid in the clarification tank (e.g. by a radar sensor mounted near the top of, or above the clarification tank wall). With the advent of automotive radar sensors, it is contemplated that such sensors can be economically adapted to use in waste fluid treatment facilities.

SBX position (proximity), SBX velocity, and SBX acceleration: Generally, any of the above described sensors can provide a position of the SBX, such as, for example, relative to a position in or above the clarification tank.

With two or more successive position measurements from one or more of any suitable position sensor system, the controller can determine if there has been SBX movement (e.g. a different vertical position between successive measurements). With two or more positions, the controller can calculate an SBX velocity. With two or more velocity measurements, e.g. three or more position measurements, the controller can calculate an acceleration of the SBX. There can be additional signal processing algorithms applied to the position, velocity, and/or acceleration measurements and/or calculations to reduce noise fluctuations which would otherwise cause the measurements to be noisy. Such digital signal processing process algorithms for noise reduction are well known in the art and can range from any suitable type of averaging to more advanced digital signal processing filters.

Location of SBX position sensor: Any suitable position sensor or proximity sensor or proximity transducer can be used to measure the SBX position with respect to a reference point, such as, for example a fixed reference point on or in the clarification tank.

While sensors such as the pressure sensor and capacitive sensors are usually designed for at least partial immersion in the fluid, other proximity (e.g. range finding) sensors can or should operate without fluid immersion. For example, as shown in FIG. 3B, a sensor 4001, e.g. an ultrasonic range sensor or an optical laser diode based sensor can be mounted above the SBX and to look down (arrow 4003, either directly down, or at a downward slant range) to a surface of the SBX. Because the SBX should not be completely submerged, a target area can be on a SBX top surface, or a dedicated target 4002 mounted on an SBX top surface. A pole affixed to either the SBX or the clarification tank or a structure connected to the clarification tank can also provide a mounting location for a sensor or for a corresponding reflection point for the sensor. Sensors, such as sensor 4001 are communicatively coupled to the controller by any suitable means such as by a wired connection 4004 or by any suitable wireless connection to controls 44 (e.g. a SCADA controller).

Sensing SBX position from near the top edge of the clarification tank: One or more sensors can be mounted near the top of the inside wall of the tank for range measurements to the SBX. However, such a sensor mounted near the top wall of the clarification tank would have a minimal range reading when the SBX is adjacent the sensor, with the range increasing as the sensor falls below or rises above the level of such a wall mounted distance or ranging sensor. In such cases, there could be additional information to tell the controller whether the SBX is below or above the sensor.

Alternative mechanical SBX position measurement (optical encoder sensor): Because the movement of the cable that raises and lowers the SBX is part of a constrained and repeatable system, monitoring the cable movement can also be used to measure the SBX position. For example, an encoder, such as a rotary encoder on a shaft caused to turn by the SBX cable can be used to measure SBX physical travel. Similarly, there could be optically readable marking on the cable with an imaging by one or more photodetectors to read a code on the cable or by an imaging camera combined with optical recognition of a linear encoded cable marking system.

Clarification tank fluid level: Similar to the SBX sensor, a clarification tank fluid level sensor can be mounted from a location high on the inside wall of the clarification tank. Or, the clarification tank fluid level sensor can be mounted above the clarification tank, such as on a pole affixed to the clarification tank wall or any suitable structure above the clarification tank. Such sensors can involve submersion (e.g. pressure sensors or capacitive sensing by introducing fluid into a column), floating targets (including floating targets riding on a rail or rod), or measurements made with respect to the fluid surface itself (e.g. optical or RF reflective time of flight measurements, or reflections of acoustic signals by ultrasonics or sonar).

Redundancy: There can also be at least two or more SBX sensors which measure the SBX position and/or at least two or more fluid level sensors which measure the fluid level in the clarification tank. The two or more sensors can be of the same type and/or same technology, or use two or more different technologies. For example, both an ultrasonic sensor and an encoder sensor and/or a pressure sensor can provide redundant measurements of the SBX position. There can be similar redundancy for the clarification tank fluid level measurement.

Once there are two or more redundant measurements, the controller can be programmed to alarm if the two or more measurements differ by more than a preset threshold value. There can be several levels of alarming. For example, for a first threshold alarm for a beyond a first difference threshold (first pre-determined difference), there can be text display, visual lamp warning, and/or audio alarm (e.g. FIG. 3B, 4034) while the wastewater treatment process is allowed to proceed. For a second or third level alarm, the process can be stopped for safety reasons. For example, if the SBX is moving at a velocity or acceleration which is beyond mechanical safety limits, the SBX can be safely brought to a stop while a notification alarm is sounded. Or, if the fluid level in the clarification tank is measured to be too high or to be increasing at too fast a rate of rise, an influent valve can be closed and/or the waste liquid treatment process can be stopped. Beyond text alarms on a local display, and audio and visual alarms (e.g. flashing lights), the controller can communicate by any available way to an operator and/or maintenance technician and/or otherwise interested party, using any suitable form of communication. For example, there can be an alarm text message, phone call, email, FAX, etc. to one or more numbers or locations. Such alarms can be radio, cell phone, or any suitable network including the Internet (FIG. 3B, 4033).

Typically, redundancy beyond two measurements (dual redundancy) is cost prohibitive for a commercial waste fluid treatment facility, such as most typically a waste water treatment facility. However, where failure is higher risk, there could be triple or greater redundancy. Situations that can merit the higher cost of triple or greater redundancy might include waste water treatment systems handling large volumes of water, where failure could mean severe flooding or dumping of untreated waste water into clean water bodies. Or, there might be greater sensor redundancy where the fluid being treated includes hazardous fluids, for example corrosive, flammable, or radioactive materials, where there could be a need for higher fault tolerance of the waste fluid treatment apparatus.

Program code to control an apparatus to clean ifs using supernatant from a clarification tank as described hereinabove can be provided on a computer readable non-transitory storage medium. A computer readable non-transitory storage medium as non-transitory data storage includes any data stored on any suitable media in a non-fleeting manner. Such data storage includes any suitable computer readable non-transitory storage medium, including, but not limited to hard drives, non-volatile RAM, SSD devices, CDs, DVDs, as well as any suitable computer readable non-transitory storage medium in the cloud or any other suitable computer readable non-transitory remote storage media, etc.

It will be understood by those skilled in the art that any suitable controller, such as, for example, any suitable computer processor based controller can be used in place of the exemplary SCADA controller of the examples described hereinabove. Such controllers are understood to include any suitable computer, desktop, laptop, notebook, workstation, tablet, programmable logic controller (PLC), Human Machine Interface (HMI), etc. Such controllers are also understood to include any suitable embedded computer including one or more processors, microcontrollers, microcomputers, and/or logic having firmware or software that can perform the functions of a computer processor.

It will be appreciated that variants of the above-disclosed and other features and functions, or alternatives thereof, can be combined into many other different systems or applications. Various presently unforeseen or unanticipated alternatives, modifications, variations, or improvements therein can be subsequently made by those skilled in the art which are also intended to be encompassed by the following claims.

What is claimed is:

1. A decanter system for separating liquid from solids in a liquid mixture tank, comprising:
a screen structure at least partially submersible in a fluid influent in said tank, having screening extending across an opening in at least a portion of an outer surface thereof for carrying out said separating and having an open interior, said screen structure defining an area within said tank, said screen structure including a liquid outlet for removal of screened liquid from within said screen structure and being constructed such that liquid cannot pass from outside of said screen structure to inside of said screen structure without passing through said screening;
a lifting mechanism attached to said structure for raising and lowering said structure with respect to said tank; and a control mechanism governing said lifting mechanism for regulating a vertical position of said structure with respect to said tank, wherein, said control mechanism comprises a first pressure sensor within said structure, a second pressure sensor within said tank; and
a proximity transducer within said tank, an effluent outlet control valve, a flow meter, and a controller.

2. The decanter system of claim 1, wherein said proximity transducer comprises a sensor technology selected from the group consisting of an optical sensor, an acoustic sensor, a radar sensor, an ultrasonic sensor, a radio frequency (RF) sensor, a magnetic sensor, and an electromagnetic (EM) sensor.

3. The decanter system of claim 1, wherein said liquid comprises water.

4. A decanter system for separating liquid from solids from a fluid in a clarification tank, comprising:
a screen box assembly (SBX) at least partially submersible in said fluid in said clarification tank, said SBX having a screen extending across an opening in at least a portion of a SBX outer surface thereof for carrying a supernatant of said fluid out said clarification tank, said SBX having an open interior, said SBX defining a volume within said tank when said SBX is lowered into said clarification tank, said SBX including a supernatant outlet for removal of screened fluid from within said SBX and being constructed such that said fluid substantially cannot pass from outside of said SBX to inside of said SBX without passing through said screening;
a lifting mechanism attached to said SBX to raise and lower said SBX to a vertical position with respect to said tank;
at least one SBX sensor to measure a position of said SBX;
at least one fluid level sensor to measure a fluid height of said fluid in said clarification tank; and
a controller communicatively coupled to said lifting mechanism, said at least one SBX sensor, and said at least one fluid level sensor, said controller programmed to control said lifting mechanism to cause said SBX to move to a different vertical position over a SBX operation cycle in response to measurements received from said at least one SBX sensor and said at least one fluid level sensor.

5. The decanter system of claim 4, wherein said decanter system further includes at least two or more SBX sensors or at least two or more fluid level sensors, and an alarm is enunciated where measurements from said at least two or more SBX sensors or said at least two or more fluid level sensors differ by more than a first pre-determined difference.

6. The decanter system of claim 5, wherein said alarm further comprises a notification selected from the group consisting of one or more lights positioned in a facility, a text message, a phone call, an email, and a FAX.

7. The decanter system of claim 5, wherein said decanter system further includes at least two or more SBX sensors or at least two or more fluid level sensors, and at least one operation of said decanter system is halted where measurements from said at least two or more SBX sensors or said at least two or more fluid level sensors differ by more than a second pre-determined difference larger than said first pre-determined difference.

8. The decanter system of claim 4, wherein said at least one SBX sensor to measure said position of said SBX or at least one fluid level sensor to measure said fluid height of said fluid in said clarification tank comprises a sensor technology selected from the group consisting of, a pressure sensor, an optical sensor, an acoustic sensor, a radio frequency (RF) sensor, a magnetic sensor, and an electromagnetic (EM) sensor.

9. The decanter system of claim 8, wherein said acoustic sensor comprises an ultrasonic or a sonar sensor.

10. The decanter system of claim 8, wherein said optical sensor comprises a lidar sensor or a ladar sensor.

11. The decanter system of claim 8, wherein said optical sensor comprises a photodetector sensor or an optical encoder sensor.

12. The decanter system of claim 8, wherein said RF sensor comprises a radar sensor.

13. The decanter system of claim 8, wherein said magnetic sensor comprises a magnetic field sensor.

14. The decanter system of claim 8, wherein said EM sensor comprises an Eddy current sensor.

15. The decanter system of claim 8, wherein said EM sensor or said RF sensor comprises a capacitive sensor.

16. The decanter system of claim 15, wherein said capacitive sensor comprises said SBX configured as a first plate of said capacitive sensor and said clarification tank configured as a second plate of said capacitive sensor, and wherein said SBX is substantially electrically isolated from said clarification tank.

17. The decanter system of claim 4, further comprising a flow meter disposed in a hose or pipe fluidly coupled to said supernatant outlet, said flow meter communicatively coupled to said controller.

18. A method for separating liquid from solids in a tank, comprising the steps of:
providing a decanter system comprising a screen structure at least partially submersible in said liquid in said tank, having screening extending across an opening in at least a portion of an outer surface thereof for carrying out said separating and having an open interior, said screen structure defining an area within said tank, said screen structure including a liquid outlet for removal of screened liquid from within said screen structure and being constructed such that liquid cannot pass from outside of said screen structure to inside of said screen structure without passing through said screening; a lifting mechanism attached to said structure for raising and lowering said structure with respect to said tank; and a control mechanism governing said lifting mechanism for regulating a vertical position of said structure with respect to said tank, wherein said control mechanism includes a first pressure sensor attached to said structure, a second pressure sensor within said tank, a proximity sensor within said tank and a an effluent outlet control valve, a flow meter, an encoder to measure said vertical position of said structure with respect to said tank and a programmable controller;
determining a setpoint flow for effluent from said tank through said effluent outlet control valve;
calculating an immersion depth for said structure in said liquid in said tank to achieve said setpoint flow;
immersing said structure to said immersion depth responsive to signals from said encoder and said proximity sensor;
monitoring output data from said first and second pressure sensors, said proximity sensor, and said flow meter to determine an instantaneous flow through said effluent outlet control valve; adjusting as needed the vertical position of said structure with respect to a fluid level in said tank to maintain said calculated immersion depth or said setpoint flow; and
adjusting said immersion depth and a position of said effluent outlet control valve as needed to provide a desired flow rate of effluent through said flow meter.

19. The method of claim 18, wherein said step of providing comprises providing said proximity sensor elected from the group consisting of, an optical sensor, an acoustic sensor, a radio frequency (RF) sensor, a magnetic sensor, and an electromagnetic (EM) sensor.

20. The method of claim 18, further comprising the step of raising said structure from said liquid in said tank to allow filtrate within said structure to back wash said screening.
